(19) United States
(12) Patent Application Publication
(10) Pub. No.: US 2025/0261012 A1
(43) Pub. Date: Aug. 14, 2025

(54) RADIO COMMUNICATION METHOD, AND RADIO COMMUNICATION SYSTEM

(71) Applicant: NIPPON TELEGRAPH AND TELEPHONE CORPORATION, Tokyo (JP)

(72) Inventors: Takeru FUKUSHIMA, Tokyo (JP); Motoharu SASAKI, Tokyo (JP); Toshiro NAKAHIRA, Tokyo (JP); Daisuke MURAYAMA, Tokyo (JP); Takatsune MORIYAMA, Tokyo (JP)

(21) Appl. No.: 18/857,305

(22) PCT Filed: Apr. 21, 2022
(86) PCT No.: PCT/JP2022/018408

§ 371 Date: Oct. 16, 2024

(51) Int. Cl. H04W 24/08

(52) U.S. Cl. CPC H04W 24/08

(57) ABSTRACT

In order to improve utilization efficiency of a wireless base station having high communication quality and smooth a difference in communication quality between wireless terminals, in a wireless communication method, a wireless base station performs setting processing of setting a threshold for determining a congestion degree of the wireless base station on a basis of an actual value of past communication, determination processing of determining a congestion degree of the wireless base station using the threshold, and change processing of changing a connection condition of the wireless base station on a basis of a congestion degree of the wireless base station.

### TECHNICAL FIELD

The present invention relates to a wireless communication method and a wireless communication system.

### BACKGROUND ART

A wireless communication system that, in connection control between a wireless base station and a wireless terminal, performs distribution processing of connection control using a blockchain technology is known (see, for example, Non Patent Literature 1).

### CITATION LIST

### Non Patent Literature

Non Patent Literature 1: X. Ling, et al., “Blockchain Radio Access Network (B-RAN): Towards Decentralized Secure Radio Access Paradigm”, IEEE Access, Volume: 7, 2019, p. 9714 9723

### SUMMARY OF INVENTION

### Technical Problem

In the conventional technology, in a situation in which a wireless terminal autonomously determines a wireless base station of a connection destination, a difference in performance for each wireless base station cannot be considered, and accordingly, there are issues that utilization efficiency of a wireless base station having high communication quality decreases, a difference in communication quality of a wireless terminal occurs, and the like.

The embodiment of the present invention has been made in view of the above issues, and provides a wireless communication method for improving utilization efficiency of a wireless base station having high communication quality and smoothing a difference in communication quality between wireless terminals.

### Solution to Problem

In order to solve the above issue, in a wireless communication method, a wireless base station performs setting processing of setting a threshold for determining a congestion degree of the wireless base station on a basis of an actual value of past communication, determination processing of determining a congestion degree of the wireless base station using the threshold, and change processing of changing a connection condition of the wireless base station on a basis of a congestion degree of the wireless base station.

### Advantageous Effects of Invention

According to the embodiment of the present invention, it is possible to provide a wireless communication method for improving utilization efficiency of a wireless base station having high communication quality and smoothing a difference in communication quality between wireless terminals.

### BRIEF DESCRIPTION OF DRAWINGS

FIG. 1 is a diagram illustrating an example of a system configuration of a wireless communication system according to the present embodiment.

FIG. 2 is a diagram illustrating an example of a functional configuration of a wireless base station according to the present embodiment.

FIG. 3 is a diagram illustrating an example of a functional configuration of a wireless terminal according to the present embodiment.

FIG. 4 is a flowchart illustrating an example of processing of the wireless base station according to the present embodiment.

FIG. 5 is a flowchart illustrating an example of processing of the wireless terminal according to the present embodiment.

FIG. 6 is a flowchart illustrating an example of connection condition change processing according to Example 1.

FIG. 7 is a diagram for describing the connection condition change processing according to Example 1.

FIG. 8 is a flowchart illustrating an example of connection condition change processing according to Example 2.

FIG. 9 is a diagram illustrating an example of a hardware configuration of the wireless base station and the wireless terminal according to the present embodiment.

### DESCRIPTION OF EMBODIMENTS

Hereinafter, an embodiment (present embodiment) of the present invention will be described with reference to the drawings. The embodiment to be described below is merely an example, and an embodiment to which the present invention is applied is not limited to the following embodiment.

### <System Configuration>

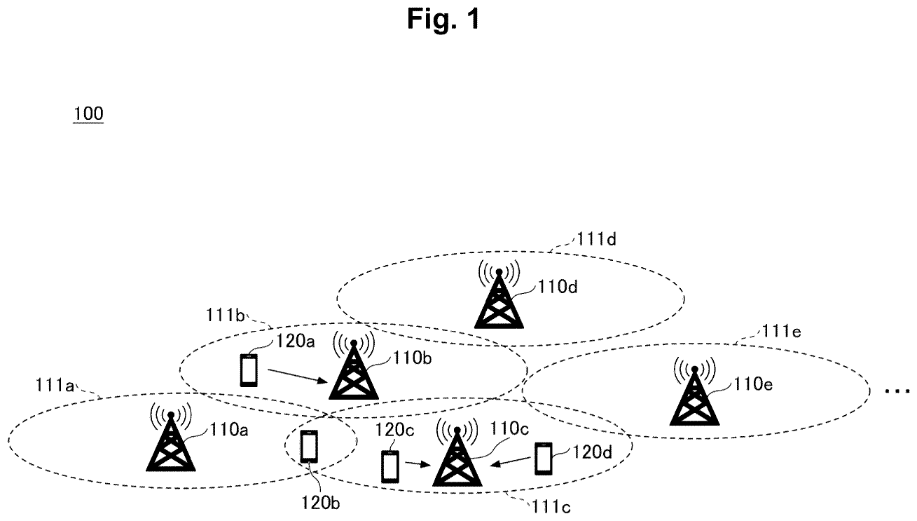

FIG. 1 is a diagram illustrating an example of a system configuration of a wireless communication system according to the present embodiment. As illustrated in FIG. 1, a wireless communication system 100 includes a plurality of wireless base stations 110a, 110b, 110c, 110d, 110e, . . . that form different network cells from each other. For example, the wireless base station 110a forms a network cell 111a and can communicate with a wireless terminal 120b in the network cell 111a. Furthermore, the wireless base station 110b forms a network cell 111b and can communicate with a wireless terminal 120a in the network cell 111b. Similarly, the wireless base station 110c forms a network cell 111c and can communicate with wireless terminals 120b, 120c, and 120d in the network cell 111c. Further, the wireless base station 110d forms a network cell 111d, and the wireless base station 110e forms a network cell 111e.

Note that, in the following description, in a case where any wireless base station among the wireless base stations 110a, 110b, 110c, 110d, 110e, . . . is indicated, “wireless base station 110” is used. Similarly, in a case where any wireless terminal among the wireless terminals 120a, 120b, 120c, and 120d is indicated, “wireless terminal 120” is used. Furthermore, the number of wireless base stations 110 and the number wireless terminals 120 illustrated in FIG. 1 are examples, and may be other numbers.

### (Outline of Processing)

Here, referring back to FIG. 1, an outline of processing of the wireless communication system 100 according to the present embodiment will be described.

Each wireless base station 110 broadcasts a connection condition for connecting to the own station to a wireless terminal 120 in a network cell 111 of the own station. The connection condition includes, for example, information of communication quality to be provided, a connection cost (connection fee) for connecting to the wireless base station 110, and the like.

A wireless terminal 120 that starts communication receives a connection condition transmitted by a wireless base station 110 in the vicinity, and determines a wireless base station 110 of which connection is requested on the basis of the connection condition. For example, the wireless terminal 120 determines a wireless base station 110 that satisfies communication quality requested by the wireless terminal 120 and has the lowest connection cost among one or more wireless base stations 110 that have received the connection condition as the wireless base station 110 of which connection is requested. As described above, the wireless communication system 100 is a system in which the wireless terminal 120 autonomously determines the wireless base station 110 of a connection destination.

However, traffic may be concentrated on a specific wireless base station 110 if the method is used alone. For example, in FIG. 1, the wireless terminal 120a is connected to the wireless base station 110b, and wireless terminals 120c and 120d are connected to the wireless base station 110c.

In the conventional technology, in a case where the wireless terminal 120b newly starts communication in this state, it is difficult to perform control such that the wireless terminal 120b is connected to the wireless base station 110a having a lower congestion degree in order to lower the congestion degree of the wireless base station 110c.

Furthermore, it is not realistic to control the optimum connection destination for all the wireless terminals 120 by centralized control by a control station that controls the wireless communication system 100 since the processing amount becomes enormous as the number of the wireless base stations 110 and the wireless terminals 120 increases.

Therefore, the wireless base station 110 according to the present embodiment includes a function of setting a threshold for determining the congestion degree of the own station (wireless base station 110) on the basis of an actual value of past communication, and determining the current congestion degree of the own station using the threshold.

As an example, the wireless base station 110 may set an average value of past communication quality of the own station (hereinafter, referred to as average communication quality) as a threshold, and determine that the wireless base station 110 is congested in a case where the value of communication quality that can be provided by the own station is smaller than the threshold.

As another example, the wireless base station 110 may set an average value of the past terminal accommodation number of the own station (hereinafter, referred to as an average terminal accommodation number) as a threshold, and determine that the own station is congested in a case where the terminal accommodation number of the own station is larger than the past average terminal accommodation number.

As described above, the wireless base station 110 according to the present embodiment determines the congestion degree of the own station on the basis of an actual value of past communication, thereby being able to determine the congestion degree of the own station in consideration of a difference in performance for each wireless base station 110.

Furthermore, the wireless base station 110 according to the present embodiment includes a function of changing the connection condition of the own station on the basis of the congestion degree of the own station. For example, in a case where the own station is congested, the wireless base station 110 increases the connection cost of the own station. Alternatively, in a case where the own station is not congested, the wireless base station 110 may lower the connection cost of the own station.

As described above, the wireless communication system 100 according to the present embodiment determines the congestion degree of each wireless base station 110 in consideration of a difference in performance of each wireless base station 110, and changes the connection condition of each wireless base station 110 on the basis of the congestion degree of each wireless base station 110. Therefore, according to the present embodiment, it is possible to provide the wireless communication system 100 and a wireless communication method for improving utilization efficiency of the wireless base station 110 having high communication quality and smoothing a difference in communication quality between the wireless terminals 120.

### <Functional Configuration>

Next, functional configurations of the wireless base station 110 and the wireless terminal 120 according to the present embodiment will be described.

### (Functional Configuration of Wireless Base Station)

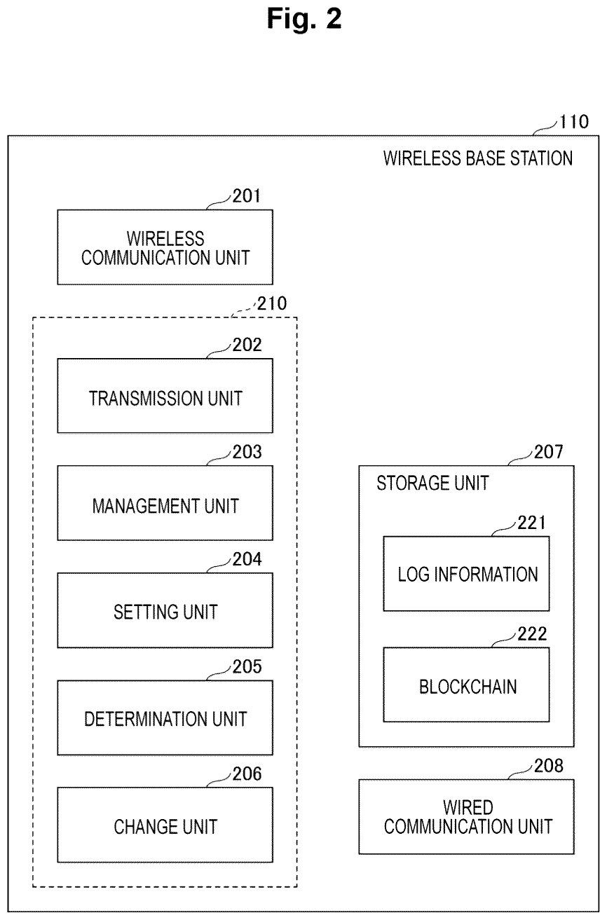

FIG. 2 is a diagram illustrating an example of a functional configuration of a wireless base station according to the present embodiment. The wireless base station 110 includes, for example, a configuration of a computer, and the computer implements a wireless communication unit 201, a transmission unit 202, a management unit 203, a setting unit 204, a determination unit 205, a change unit 206, a storage unit 207, a wired communication unit 208, and the like by executing a predetermined program. Note that at least some of the functional configurations described above may be implemented by hardware.

The wireless communication unit 201 forms the network cell 111 capable of performing wireless communication with the wireless base station 110, and performs wireless communication processing of performing wireless communication with the wireless terminal 120 connected to the wireless base station 110.

The transmission unit 202 performs transmission processing of broadcasting a connection condition for connecting to the wireless base station 110 to the wireless terminal 120 in the network cell 111 of the wireless base station 110. The connection condition includes, for example, information of communication quality provided by the wireless base station 110, a connection cost (connection fee) for connecting to the wireless base station 110, and the like.

For example, the management unit 203 performs management processing of storing and managing log information 221 including information of a wireless terminal 120 connected to the wireless base station 110 on the basis of the connection condition transmitted by the transmission unit 202 and information of the communication quality to be provided to the wireless terminal 120 and the like in the storage unit 207 or the like.

Note that the management unit 203 may record and manage information of a wireless terminal 120 connected to the wireless base station 110 and information of communication quality provided to the wireless terminal 120 and the like in a blockchain 222 as in the technology disclosed in Non Patent Literature 1, for example. Here, the following description will be given on the assumption that the management unit 203 stores and manages the log information 221 including information of a wireless terminal 120 connected to the wireless base station 110 and information of the communication quality to be provided to the wireless terminal 120 and the like in the storage unit 207.

The setting unit 204 performs setting processing of setting a threshold for determining a congestion degree of a wireless base station 110 on the basis of an actual value of past communication of the wireless base station 110. For example, the setting unit 204 may set past average communication quality of a wireless base station 110 as the threshold, or may set a past average terminal accommodation number of the own station as a threshold.

The determination unit 205 performs determination processing of determining a congestion degree of a wireless base station 110 using a threshold set by the setting unit 204. For example, the determination unit 205 may determine that the wireless base station 110 is congested in a case where the value of communication quality that can be provided by the wireless base station 110 is smaller than the past average communication quality of the own station (example of the threshold). Alternatively, the determination unit 205 may determine that the own station is congested in a case where the number of wireless terminals 120 connected to the wireless base station 110 (terminal accommodation number) is larger than the past average terminal accommodation number (another example of the threshold).

The change unit 206 performs change processing of changing the connection condition of the wireless base station 110 on the basis of the congestion degree of the wireless base station 110. For example, in a case where the own station (wireless base station 110) is congested, the change unit 206 increases the connection cost of the own station. Furthermore, in a case where the own station is not congested, the change unit 206 may lower the connection cost of the own station.

Here, the connection cost is a cost for a wireless terminal 120 connecting to a wireless base station 110 (for example, connection fee), and the wireless terminal 120, for example, preferentially connects to a wireless base station 110 having the lowest connection cost among wireless base stations 110 that satisfy required communication quality.

Note that, in a case where the distance between the wireless base station 110 and the wireless terminal 120 is short, the transmission power can be reduced, and in a case where the communication speed between the wireless base station 110 and the wireless terminal 120 is high, the communication time can be shortened. Therefore, the wireless terminal 120 may determine a wireless base station 110 to be connected on the basis of a received signal strength from the wireless base station 110, the communication speed, or the like in addition to the connection cost.

Note that the transmission unit 202, the management unit 203, the setting unit 204, the determination unit 205, the change unit 206, and the like are included in, for example, a communication control unit 310 that controls wireless communication by the wireless communication unit 201.

The storage unit 207 performs storage processing of storing various types of data, information, programs, and the like including the log information 221, the blockchain 222, or the like in, for example, a storage device or the like included in the wireless base station 110.

The wired communication unit 208 connects the wireless base station 110 to, for example, a wired communication network and communicates with other wireless base stations 110 and the like.

### (Functional Configuration of Wireless Terminal)

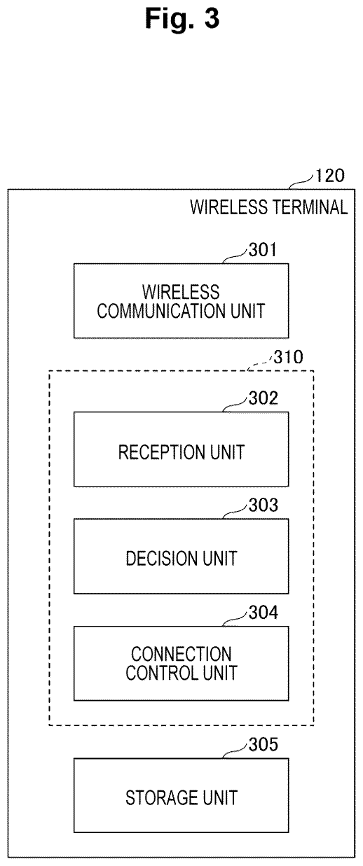

FIG. 3 is a diagram illustrating an example of a functional configuration of a wireless terminal according to the present embodiment. The wireless terminal 120 includes, for example, a configuration of a computer, and the computer implements a wireless communication unit 301, a reception unit 302, a decision unit 303, a connection control unit 304, a storage unit 305, and the like by executing a predetermined program. Note that at least some of the functional configurations described above may be implemented by hardware.

The wireless communication unit 301 is connected to the wireless base station 110 by wireless communication and performs wireless communication processing of transmitting and receiving data. The reception unit 302 performs reception processing of receiving a connection condition transmitted by the wireless base station 110 using the wireless communication unit 301.

The decision unit 303 determines a wireless base station 110 of which the wireless terminal 120 requests connection on the basis of a connection condition received by the reception unit 302. For example, the wireless terminal 120 preferentially connects to a wireless base station 110 having the lowest connection cost among wireless base stations 110 that satisfy the required communication quality. Note that, in a case where the distance between the wireless base station 110 and the wireless terminal 120 is short, the transmission power can be reduced, and in a case where the communication speed between the wireless base station 110 and the wireless terminal 120 is high, the communication time can be shortened. Therefore, the wireless terminal 120 desirably determines a wireless base station 110 of a connection destination on the basis of the communication quality of a wireless base station 110 and the connection cost.

The connection control unit 304 performs connection processing of connecting to a wireless base station 110 of a connection destination determined by the decision unit 303. Note that the reception unit 302, the decision unit 303, the connection control unit 304, and the like are included in, for example, a communication control unit 310 that controls wireless communication by the wireless communication unit 301.

The storage unit 305 performs storage processing of storing various types of data, information, programs, and the like necessary for wireless communication in, for example, a storage device or the like included in the wireless terminal 120.

### <Flow of Processing>

Next, a flow of processing of a wireless communication method according to the present embodiment will be described with a plurality of examples.

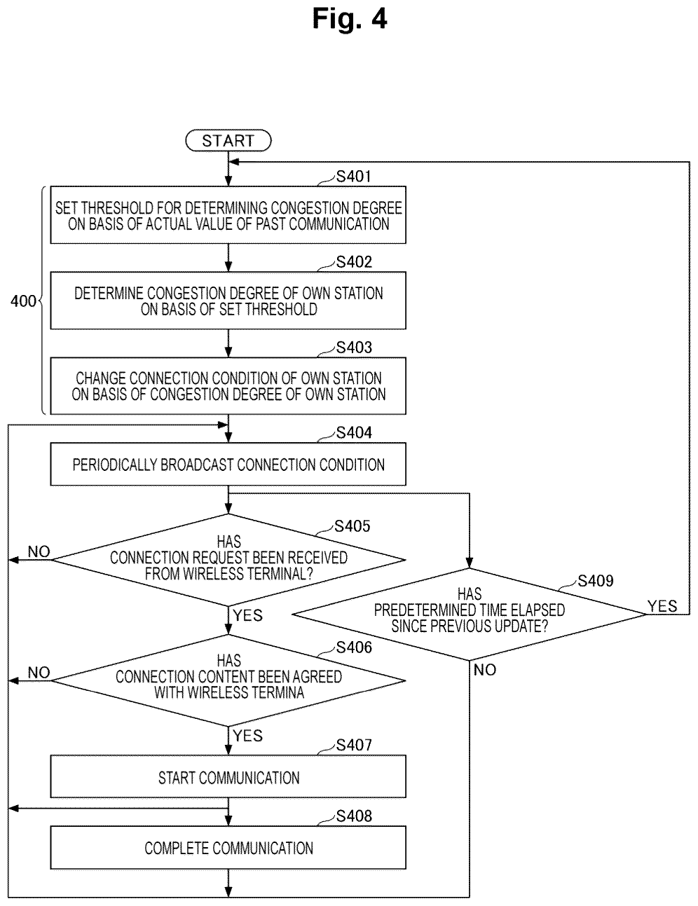

(Processing of Wireless Base Station) FIG. 4 is a flowchart illustrating an example of processing of the wireless base station according to the present embodiment. This processing illustrates the overall flow of processing performed by the wireless base station 110 described in FIG. 2.

In step S401, the setting unit 204 sets a threshold for determining a congestion degree of the own station on the basis of an actual value of past communication of the own station (wireless base station 110). For example, as described above, the setting unit 204 may set past average communication quality of the own station as a threshold, or may set past average terminal accommodation number of the own station as a threshold. Note that the setting unit 204 may use a value other than the past average communication quality and the average terminal accommodation number as a threshold for determining the congestion degree of the own station.

In step S402, the determination unit 205 performs determination processing of determining a congestion degree of a wireless base station 110 using a threshold set by the setting unit 204. For example, the determination unit 205 may determine that the wireless base station 110 is congested in a case where the value of communication quality that can be provided by the wireless base station 110 is smaller than the past average communication quality of the own station (example of the threshold).

Alternatively, the determination unit 205 may determine that the own station is congested in a case where the number of wireless terminals 120 connected to the wireless base station 110 (terminal accommodation number) is larger than the past average terminal accommodation number (another example of the threshold).

In step S403, the change unit 206 performs change processing of changing the connection condition of the own station on the basis of the congestion degree of the own station (wireless base station 110). For example, as described above, in a case where the own station is congested, the change unit 206 increases the connection cost of the own station. Furthermore, in a case where the own station is not congested, the change unit 206 may lower the connection cost of the own station.

In step S404, the transmission unit 202 broadcasts the connection condition using the wireless communication unit 201. For example, the transmission unit 202 periodically transmits a notification message including the connection condition including information of the communication quality of wireless communication provided by the own station (wireless base station 110), the connection cost, and the like by wireless communication.

In step S405, the communication control unit 210 determines whether the wireless communication unit 201 has received a connection request from a wireless terminal 120, and performs processing in and after step S406 in a case where the connection request has been received. On the other hand, in a case where the connection request has not been received, the communication control unit 210 returns the processing to step S404.

In a case where the processing proceeds to step S406, the communication control unit 210 determines whether the connection content is agreed with the wireless terminal 120, and in a case where the connection content is agreed with the wireless terminal 120, the processing proceeds to step S407. On the other hand, in a case where the connection content is not agreed with the wireless terminal 120, the communication control unit 210 returns the processing to step S404.

In a case where the processing proceeds to step S407, the wireless base station 110 starts communication with the wireless terminal 120 that has transmitted the connection request, and returns the processing to step S404. In step S408, in a case where the communication is completed, the wireless base station 110 returns the processing to step S404.

Note that the setting unit 204 performs processing of step S409 in parallel with processing of steps S404 to S408, for example.

In step S409, the setting unit 204 determines whether a predetermined time has elapsed since the previous performing of processing 400 of steps S401 to S403. Here, the predetermined time is a preset connection cost update interval. In a case where the predetermined time has elapsed, the setting unit 204 performs the processing 400 of steps S401 to S403 again. In a case where the predetermined time has not elapsed, the setting unit 204 returns processing to step S404 and waits until the predetermined time elapses.

Through the above processing, the wireless base station 110 changes the connection condition of the wireless base station 110 on the basis of an actual value of past communication of the own station. Furthermore, by each wireless base station 110 included in the wireless communication system 100 performing the processing of FIG. 4, the wireless communication system 100 according to the present embodiment can set the connection condition of each wireless base station 110 in consideration of a difference in performance (communication quality) for each wireless base station 110.

### (Processing of Wireless Terminal)

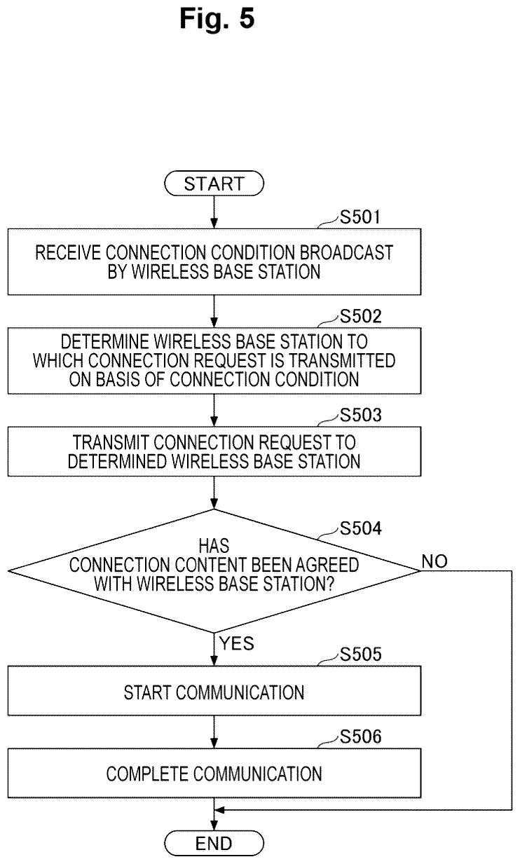

FIG. 5 is a flowchart illustrating a flow of processing of the wireless terminal according to the present embodiment. This processing is an example of processing performed in a case where the wireless terminal 120 described with reference to FIG. 3 starts wireless communication.

In step S501, the reception unit 302 receives a connection condition broadcast by the wireless base station 110. As described above, the connection condition includes information of communication quality of the wireless communication provided by the wireless base station 110, a connection cost, and the like.

In step S502, the decision unit 303 determines a wireless base station 110 of which the wireless terminal 120 requests connection on the basis of the connection condition received by the reception unit 302. For example, the decision unit 303 may determine a wireless base station 110 having the lowest connection cost among wireless base stations 110 that satisfy the required communication quality as the wireless base station 110 of which connection is required. Furthermore, in a case where there is a plurality of wireless base stations 110 having the same connection cost, the decision unit 303 may determine a wireless base station 110 having the highest communication quality (for example, throughput, received power, or the like) as the wireless base station 110 of which connection is required.

In step S503, the connection control unit 304 transmits a connection request for requesting connection of wireless communication to the wireless base station 110 determined by the decision unit 303.

In step S504, the connection control unit 304 determines whether the connection content is agreed with the wireless base station 110, and proceeds the processing to step S505 in a case where the connection content is agreed. On the other hand, in a case where the connection content is not agreed, the wireless terminal 120 ends the processing of FIG. 5.

In a case where the processing proceeds to step S505, the wireless terminal 120 starts communication with the wireless base station 110 of the connection destination, and in a case where the communication is completed in step S506, the processing of FIG. 5 ends.

Through the above processing, the wireless terminal 120 preferentially connects to a wireless base station 110 having a lower connection cost among wireless base stations 110 in the vicinity.

Note that, in a case where the communication quality deteriorates during communication, the wireless terminal 120 may perform the processing of FIG. 5 again and switch the connection destination to a new wireless base station 110. Furthermore, in a case where the communication cost of the wireless base station 110 increases during communication, the wireless terminal 120 may perform the processing of FIG. 5 again and switch the connection destination to a new wireless base station 110.

### <Connection Condition Change Processing>

Next, connection condition change processing performed by the wireless base station 110 will be described with specific examples.

### Example 1

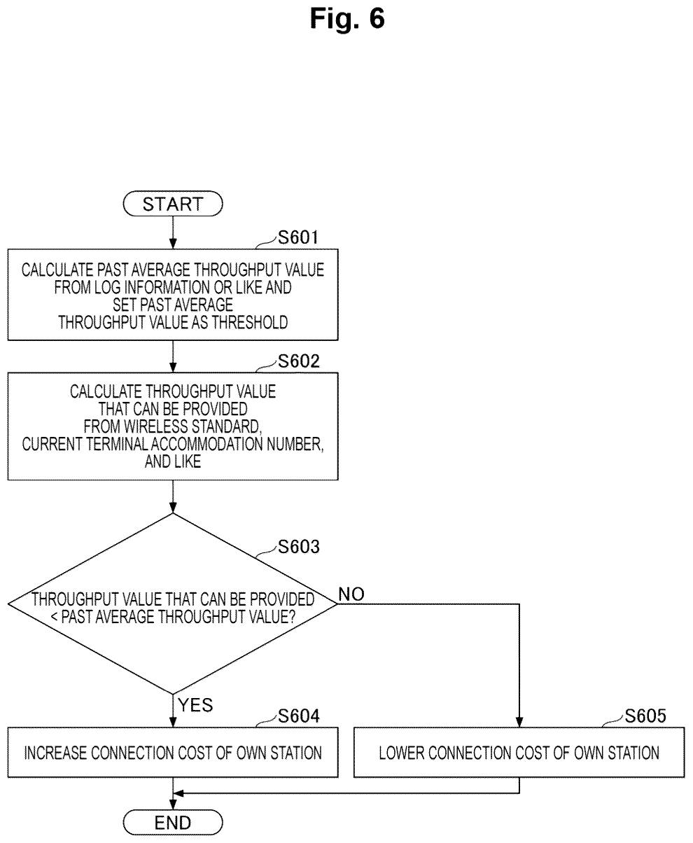

FIG. 6 is a flowchart illustrating an example of connection condition change processing according to Example 1. This processing illustrates, for example, a specific example of the processing 400 of steps $401 to S403 in FIG. 4.

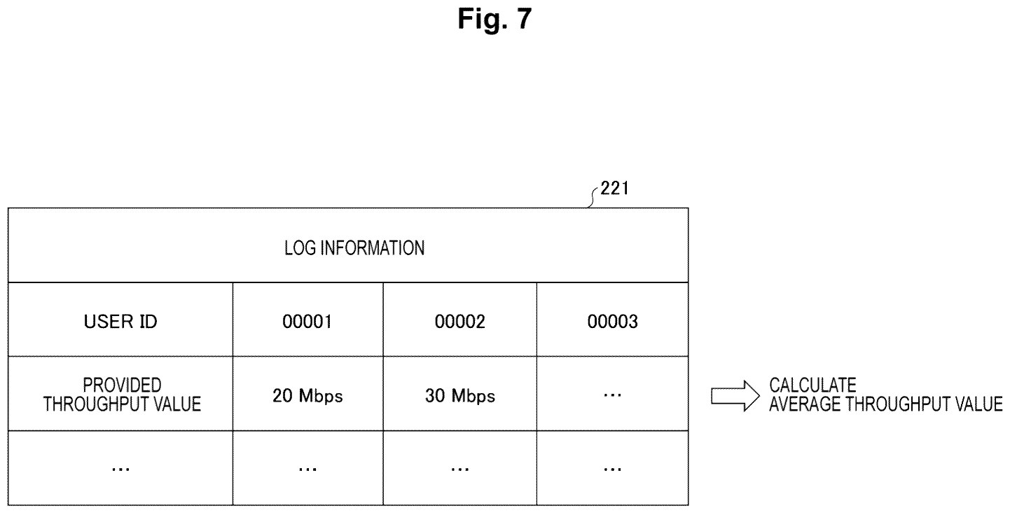

In step S601, the setting unit 204 of the wireless base station 110 calculates the past average throughput value of the wireless base station 110 from, for example, the log information 221 stored in the storage unit 207. For example, as illustrated in FIG. 7, the log information 221 stores throughput values of wireless communication provided to each wireless terminal 120 (provided throughput values) in past communication with the wireless terminal 120. For example, the setting unit 204 calculates the past average throughput value by averaging provided throughput values in a predetermined period or the entire period. Furthermore, the setting unit 204 sets the calculated past average throughput value as a threshold for determining the congestion degree of the wireless base station 110.

In step S602, the determination unit 205 of the wireless base station 110 calculates a throughput value that can be provided to the wireless terminal 120 from, for example, the wireless standard, the current terminal accommodation number, and the like. Here, the current terminal accommodation number is the number of wireless terminals 120 currently connected to the wireless base station 110.

In step S603, the determination unit 205 compares the throughput value that can be provided by the wireless base station 110 with the set threshold (past average throughput value) and determines the congestion degree of the wireless base station 110. For example, the determination unit 205 determines that the wireless base station 110 is congested in a case where the throughput value (example of communication quality) that can be provided by the wireless base station 110 is smaller than the past average throughput value (threshold). On the other hand, the determination unit 205 determines that the wireless base station 110 is not congested in a case where the throughput value that can be provided by the wireless base station 110 is equal to or larger than the past average throughput value (threshold).

In a case where the throughput value that can be provided by the wireless base station 110 is smaller than the past average throughput value (threshold), that is, a case where the wireless base station 110 is congested, the determination unit 205 proceeds the processing to step S604. On the other hand, in a case where the throughput value that can be provided by the wireless base station 110 is equal to or larger than the past average throughput value (threshold), that is, a case where the wireless base station 110 is not congested, the determination unit 205 proceeds the processing to step S605.

In a case where the processing proceeds to step S604, the change unit 206 of the wireless base station 110 increases the connection cost of the own station (wireless base station 110). On the other hand, in a case where the processing proceeds to step S605, the change unit 206 lowers the connection cost of the own station. Note that a constant value may be used as the increase/decrease width of the connection cost, or the increase/decrease width may be set to be larger as the difference between the throughput value that can be provided and the past throughput value is larger.

Note that, in the above description, the threshold is the average value of the past throughputs, but the threshold may be, for example, a representative value other than the average value, such as a median value of the past throughputs. Furthermore, the period referred to in a case of calculating the representative value may be, for example, a predetermined period such as the past 24 hours, the past one week, or the past one month, or may be, for example, a predetermined period classified into a day of the week, a time zone, or the like.

### Example 2

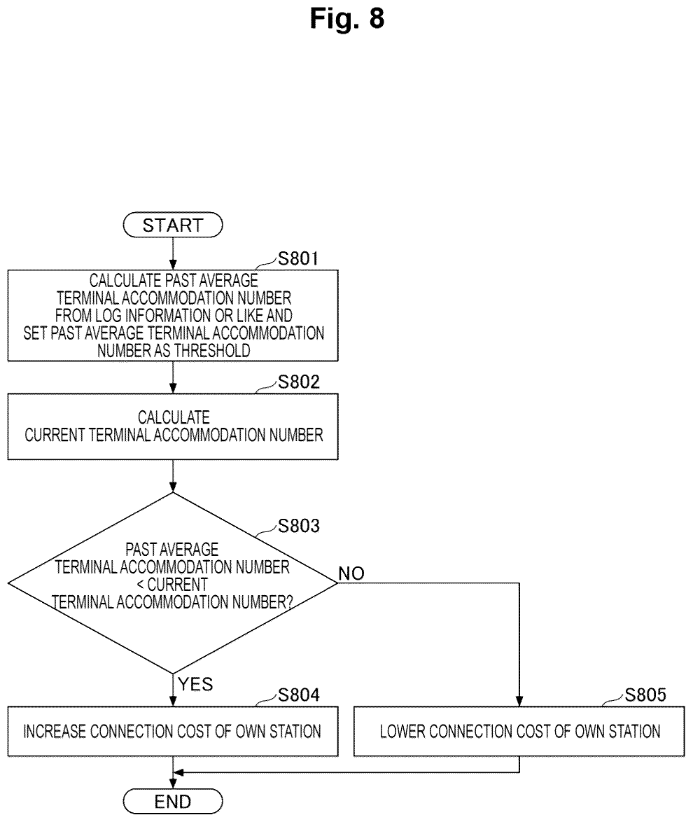

FIG. 8 is a flowchart illustrating an example of connection condition change processing according to Example 2. This processing illustrates, for example, a specific example of the processing 400 of steps S401 to S403 in FIG. 4.

In step S801, the setting unit 204 of the wireless base station 110 calculates the past average terminal accommodation number of the wireless base station 110 from, for example, the log information 221 stored in the storage unit 207. Here, the past average terminal accommodation number is an average value of terminal accommodation numbers of the wireless base station 110 stored in the log information 221 or the like. Furthermore, the terminal accommodation number of the wireless base station 110 is the number of wireless terminals 120 connected to the wireless base station 110. Furthermore, the setting unit 204 sets the calculated past average terminal accommodation number of the wireless base station 110 as a threshold for determining the congestion degree of the wireless base station 110.

In step S802, the determination unit 205 of the wireless base station 110 calculates the current terminal accommodation number of the wireless base station 110.

In step S803, the determination unit 205 compares the current terminal accommodation number of the wireless base station 110 with the threshold (past average terminal accommodation number) and determines the congestion degree of the wireless base station 110. For example, in a case where the current terminal accommodation number of the wireless base station 110 is larger than the past average terminal accommodation number (threshold), the determination unit 205 determines that the wireless base station 110 is congested. On the other hand, in a case where the current terminal accommodation number of the wireless base station 110 is equal to or smaller than the past average terminal accommodation number (threshold), the determination unit 205 determines that the wireless base station 110 is not congested.

In a case where the current terminal accommodation number of the wireless base station 110 is larger than the past average terminal accommodation number (threshold), that is, a case where the wireless base station 110 is congested, the determination unit 205 proceeds the processing to step S804. On the other hand, in a case where the current terminal accommodation number of the wireless base station 110 is equal to or smaller than the past average terminal accommodation number (threshold), that is, a case where the wireless base station 110 is not congested, the determination unit 205 proceeds the processing to step S805.

In a case where the processing proceeds to step S804, the change unit 206 of the wireless base station 110 increases the connection cost of the own station (wireless base station 110). On the other hand, in a case where the processing proceeds to step S805, the change unit 206 lowers the connection cost of the own station. Note that a constant value may be used as the increase/decrease width of the connection cost, or the increase/decrease width may be set to be larger as the difference between the current terminal accommodation number of the wireless base station 110 and the past average terminal accommodation number is larger.

Note that, in the above description, the threshold is the average value of the past terminal accommodation numbers, but the threshold may be, for example, a representative value other than the average value, such as a median value of the past terminal accommodation numbers. Furthermore, the period referred to in a case of calculating the representative value may be, for example, a predetermined period such as the past 24 hours, the past one week, or the past one month, or may be, for example, a predetermined period classified into a day of the week, a time zone, or the like.

### <Hardware Configuration Example>

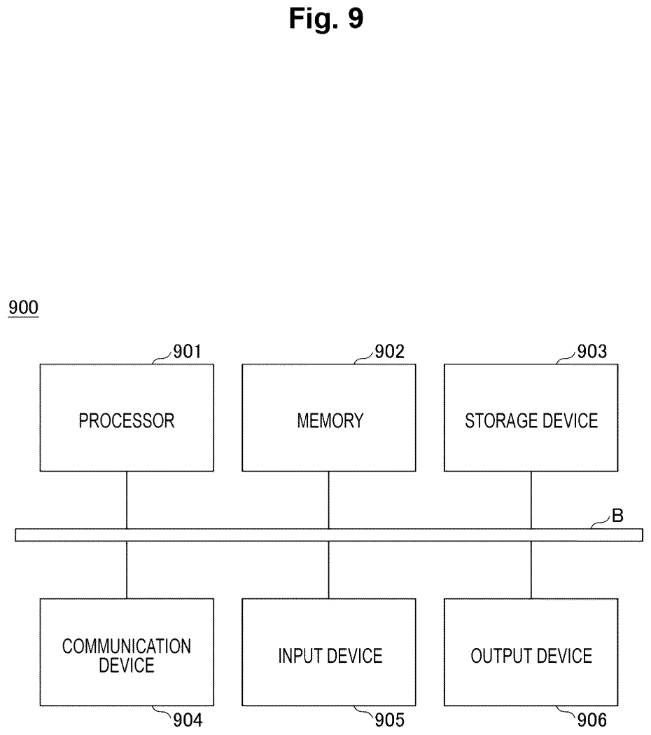

FIG. 9 is a diagram illustrating an example of a hardware configuration of the wireless base station and the wireless terminal according to the present embodiment. The wireless base station 110 and the wireless terminal 120 include, for example, a configuration of a computer 900 as illustrated in FIG. 9. In the example of FIG. 9, the computer 900 includes a processor 901, a memory 902, a storage device 903, a communication device 904, an input device 905, an output device 906, and a bus B.

The processor 901 is, for example, an arithmetic device such as a central processing unit (CPU) that implements various functions by executing a predetermined program. The memory 902 is a storage medium readable by the computer 900, and includes, for example, a random access memory (RAM) or a read only memory (ROM). The storage device 903 is a computer-readable storage medium, and can include, for example, a hard disk drive (HDD), a solid state drive (SSD), various optical disks, and a magneto-optical disk.

The communication device 904 includes one or more pieces of hardware (communication device) for communicating with other devices via a wireless or wired network. For example, the communication device 904 of the computer 900 included in the wireless base station 110 includes a communication device for performing wireless communication and a communication device for performing wired communication. Furthermore, the communication device 904 of the computer 900 included in the wireless terminal 120 includes a communication device for performing wireless communication.

The input device 905 is an input device (e.g., a keyboard, a mouse, a microphone, a switch, a button, or a sensor) that receives an input from the outside. The output device 906 is an output device (e.g., a display, a speaker, or an LED lamp) that performs output to the outside. The input device 905 and the output device 906 may be integrated (e.g., an input/output device such as a touch panel display).

The bus B is commonly connected to the above-described components, and transmits, for example, an address signal, a data signal, and various control signals. The processor 901 is not limited to a CPU, and may be, for example, a digital signal processor (DSP), a programmable logic device (PLD), or a field programmable gate array (FPGA).

### (Supplement)

The wireless base station 110 and the wireless terminal 120 in the present embodiment are not necessarily implemented by dedicated devices, but may be implemented by general-purpose computers. In that case, a program for implementing the functions may be recorded in a computer-readable recording medium, and the functions may be implemented by loading the program recorded in this recording medium to a computer system, and executing the program. Note that the “computer system” mentioned herein includes an OS and hardware such as peripheral devices.

The “computer-readable recording medium” includes various storage devices such as a portable medium such as a flexible disk, a magneto-optical disk, a ROM, and a CD-ROM, and a hard disk built in the computer system. Furthermore, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case.

In addition, the program may be for implementing some of the above-described functions, may be capable of implementing the above-described functions in combination with a program already recorded in a computer system, or may be implemented by using hardware such as a programmable logic device (PLD) or a field programmable gate array (FPGA).

### Effects of the Embodiments

As described above, according to the present embodiment, it is possible to provide a wireless communication method for improving utilization efficiency of a wireless base station having high communication quality and smoothing a difference in communication quality between wireless terminals. Furthermore, according to the present embodiment, the wireless base station 110 can obtain the above effect even in a wireless communication system 100 that cannot acquire information of other wireless base stations 110 from a blockchain 222.

### Summary of Embodiment

The present specification discloses at least the wireless communication method and the wireless communication system in the following clauses.

### (Clause 1)

A wireless communication method, in which
a wireless base station performs:
setting processing of setting a threshold for determining a congestion degree of the wireless base station on a basis of an actual value of past communication;
determination processing of determining a congestion degree of the wireless base station using the threshold; and
change processing of changing a connection condition of the wireless base station on a basis of a congestion degree of the wireless base station.

### (Clause 2)

The wireless communication method according to Clause 1, in which,
in the setting processing, an actual value of past communication quality of the wireless base station is set as the threshold, and,
in the determination processing, the wireless base station is determined to be congested in a case where a value of communication quality that can be provided by the wireless base station is smaller than the threshold.

### (Clause 3)

The wireless communication method according to Clause 1, in which,
in the setting processing, an actual value of past terminal accommodation number of the wireless base station is set as the threshold, and,
in the determination processing, the wireless base station is determined to be congested in a case where a current terminal accommodation number of the wireless base station is larger than the threshold.

### (Clause 4)

The wireless communication method according to any one of Clauses 1 to 3, in which, in the change processing, a connection cost of the wireless base station is increased in a case where the wireless base station is congested.

### (Clause 5)

The wireless communication method according to any one of Clauses 1 to 3, in which, in the change processing, a connection cost of the wireless base station is lowered in a case where the wireless base station is not congested.

### (Clause 6)

A wireless communication system including a plurality of wireless base stations and a wireless terminal, in which
a wireless base station includes:
a setting unit that sets a threshold for determining a congestion degree of the wireless base station on a basis of an actual value of past communication;
a determination unit that determines a congestion degree of the wireless base station using the threshold; and
a change unit that changes a connection condition of the wireless base station on a basis of a congestion degree of the wireless base station, and
the wireless terminal includes:
a reception unit that receives the connection condition; and
a decision unit that determines the wireless base station of which the wireless terminal requests connection on a basis of the connection condition.

While the present embodiment has been described above, the present invention is not limited to such a specific embodiment, and various modifications and changes can be made within the scope of the present invention described in the claims.

### REFERENCE SIGNS LIST

100 Wireless communication system
110, 110a to 110e Wireless base station
120, 120a to 120d Wireless terminal
204 Setting unit
205 Determination unit
206 Change unit
221 Log information
302 Reception unit
303 Decision unit

1. A wireless communication method comprising:
setting, by a wireless base station, a threshold for determining a congestion degree of the wireless base station on a basis of an actual value of past communication;
determining, by the wireless base station, a congestion degree of the wireless base station using the threshold; and
changing, by the wireless base station, a connection condition of the wireless base station on a basis of a congestion degree of the wireless base station.

2. The wireless communication method according to claim 1, wherein,
in the setting, an actual value of past communication quality of the wireless base station is set as the threshold, and,
in the determining, the wireless base station is determined to be congested in a case where a value of communication quality that can be provided by the wireless base station is smaller than the threshold.

3. The wireless communication method according to claim 1, wherein,
in the setting, an actual value of past terminal accommodation number of the wireless base station is set as the threshold, and,
in the determining, the wireless base station is determined to be congested in a case where a current terminal accommodation number of the wireless base station is larger than the threshold.

4. The wireless communication method according to claim 1, wherein, in the changing, a connection cost of the wireless base station is increased in a case where the wireless base station is congested.

5. The wireless communication method according to claim 1, wherein, in the changing, a connection cost of the wireless base station is lowered in a case where the wireless base station is not congested.

6. A wireless communication system comprising a plurality of wireless base stations and a wireless terminal, wherein
among the plurality of wireless base stations, each wireless base station includes:
a memory; and
a processor coupled to the memory and configured to:
set a threshold for determining a congestion degree of the each wireless base station on a basis of an actual value of past communication;
determine a congestion degree of the each wireless base station using the threshold; and
change a connection condition of the each wireless base station on a basis of a congestion degree of the each wireless base station, and
the wireless terminal includes:
a memory; and
a processor coupled to the memory and configured to:
receive the connection condition; and
determine a wireless base station, among the plurality of wireless base stations, of which the wireless terminal requests connection, on a basis of the connection condition.
